(19) United States
(12) Patent Application Publication
(10) Pub. No.: US 2002/0143698 A1
(43) Pub. Date: Oct. 3, 2002

(54) Management system and management method for booking or purchase information

(75) Inventor: Akira Shiramizu, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/107,331

(22) Filed: Mar. 28, 2002

(30) Foreign Application Priority Data
Mar. 30, 2001 (JP) 2001-100156

(51) Int. Cl. G06F 17/60

(52) U.S. Cl. 705/39

(57) ABSTRACT

So that a purchaser can book and purchase a commodity without having to bear anything extra other than what he or she usually bear, purchaser terminal unit 10 transmits to a credit card company terminal unit 40 commodity booking information and a credit card number designated by the purchaser, and the credit card company terminal unit 40 stores the booking information and the credit card number matched with each other. A retail store terminal unit 30 enters the credit card number from the credit card presented by the purchaser, transmits that credit card number to the credit card company terminal unit 40 to have the matching booking information returned, and cause the commodity matching that booking information to be sold to the purchaser.

### BACKGROUND OF THE INVENTION

1. Field of the Invention

The present invention relates to a management system and a management method for booking information notified when the purchase of a commodity is booked and required when the commodity is to be actually purchased and purchase information notified when a commodity is purchased and required when the commodity is to be received.

2. Description of the Related Art

According to the prior art, a purchaser having booked the purchase of a commodity via such a medium of communication as telephone or the Internet, writes down in a notebook or memorizes a booking number notified by the site selling the commodity, tells that booking number at the store where he or she actually purchases the commodity and purchases it.

Or, even if the purchaser actually purchases the commodity, he or she cannot immediately receive the commodity at the store, and instead receive a coupon to be exchanged with the commodity. In that case, the purchaser presents the coupon at the delivery site of the commodity and receives the commodity in exchange for the coupon.

However, this conventional commodity purchase booking method involves the problem that the purchaser may lose the note on which the booking number is written or his or her own memory of the booking number, and in that case it would be impossible to purchase the commodity.

The above-described commodity purchasing method according to the prior art also involves the purchaser may lose the coupon to be exchanged with the commodity and become unable to receive the commodity.

These problems derive from the need to keep something extra which the purchaser usually would not have to keep, whether it may be a note on which the booking number is written or the coupon, in order to purchase the commodity.

### SUMMARY AND OBJECTS OF THE INVENTION

An object of the present invention to enable a purchaser to book and purchase a commodity without having to keep anything special which he or she usually would not have to keep.

A first booking information management system according to the invention comprises a credit card company terminal unit for storing sale information and a credit card number matched with each other; and a retail store terminal unit for acquiring, in response to the entry of a credit card number, said booking information matching the credit card number from said credit card company terminal unit, and displaying commodity information pertaining to that booking information.

A second booking information management system according to the invention comprises a purchaser terminal unit for transmitting a credit card number and commodity information to a retail store terminal unit, wherein said retail store terminal unit transmits to a credit card company terminal unit said credit card number and booking information pertaining to said commodity information received from said purchaser terminal unit and causes them to be stored matched with each other; in response to the entry of the credit card number, transmits that credit card number to said credit card company terminal unit to cause said booking information matching that credit card number to be read out; receives that booking information from that credit card company terminal unit; and displays commodity information pertaining to that booking information.

A third booking information management system according to the invention comprises a purchaser terminal unit for displaying commodity sale information and transmitting commodity information selected from that sale information and an entered credit card number to a retail store terminal unit, wherein said retail store terminal unit transmits to a credit card company terminal unit said credit card number and booking information pertaining to said commodity information received from said purchaser terminal unit and causes them to be stored matched with each other; transmits to said purchaser terminal unit a notice that booking for the commodity pertaining to that commodity information has been completed; displays an instruction to secure the availability of that commodity; in response to the entry of the credit card number, transmits that credit card number to said credit card company terminal unit to cause said booking information matching that credit card number to be read out; receives that booking information from that credit card company terminal unit; and displays commodity information pertaining to that booking information.

A fourth booking information management system according to the invention comprises a purchaser terminal unit for transmitting an entered credit card number and commodity information to a commodity sale information providing unit, wherein said commodity sale information providing unit transmits to a credit card company terminal unit said credit card number and booking information pertaining to said commodity information received from said purchaser terminal unit and causes them to be stored matched with each other; and a retail store terminal unit, in response to the entry of the credit card number, transmits that credit card number to said credit card company terminal unit to cause said booking information matching that credit card number to be read out; receives that booking information from that credit card company terminal unit; and displays commodity information pertaining to that booking information.

A fifth booking information management system according to the invention comprises a purchaser terminal unit for displaying commodity sale information and transmitting commodity information selected from that sale information and entered credit card number to a commodity sale information providing unit; wherein said commodity sale information providing unit transmits to a credit card company terminal unit said credit card number and booking information pertaining to said commodity information received from said purchaser terminal unit and causes them to be stored matched with each other; and transmits to said purchaser terminal unit and a retail store terminal unit a notice that booking for the commodity pertaining to that commodity information has been completed; and said retail store terminal unit receives from said commodity sale information terminal unit the notice that booking for the commodity has been completed; displays an instruction to secure the availability of that commodity; in response to the entry of the credit card number, transmits that credit card number to said credit card company terminal unit to cause said booking information matching that credit card number to be read out; receives that booking information from that credit card company terminal unit; and displays commodity information pertaining to that booking information.

A sixth booking information management system according to the invention is a version of any of the first through fifth booking information management system, wherein the counterpart of said credit card number is an account number and that of said credit card company terminal unit is a financial institution terminal unit.

A first retail store terminal unit according to the invention transmits a credit card number and booking information pertaining to commodity information to a credit card company terminal unit to cause them to be stored matched with each other; in response to the entry of the credit card number, transmits that credit card number to said credit card company terminal unit to cause said booking information matching that credit card number to be read out; receives that booking information from that credit card company terminal unit; and displays commodity information pertaining to that booking information.

A second retail store terminal unit according to the invention transmits to a credit card company terminal unit a credit card number and booking information pertaining to commodity information received from a purchaser terminal unit to cause them to be stored matched with each other; transmits to said purchaser terminal unit a notice that booking for the commodity pertaining to that commodity information has been completed; displays an instruction to secure the availability of that commodity; in response to the entry of the credit card number, transmits that credit card number to said credit card company terminal unit to cause said booking information matching that credit card number to be read out; receives that booking information from that credit card company terminal unit; and displays commodity information pertaining to that booking information.

A third retail store terminal unit according to the invention is a version of either of the first or second booking information management system, wherein the counterpart of said credit card number is an account number and that of said credit card company terminal unit is a financial institution terminal unit.

A fourth retail store terminal unit according to the invention transmits an identification number and booking information pertaining to commodity information to a financial institution terminal unit and causes them to be stored matched with each other; in response to the entry of the identification number, transmits the identification number to said financial institution terminal unit wherein matching between identification numbers and account numbers is stored in advance to cause the identification number to be converted into the matching account number; causes said booking information matching that account number to be read out; receives that booking information from that financial institution terminal unit; and displays commodity information pertaining to that booking information.

A fifth retail store terminal unit according to the invention transmits an identification number and booking information pertaining to commodity information received from a purchaser terminal unit to a financial institution terminal unit and causes them to be stored matched with each other; transmits a notice of completion of booking for the commodity pertaining to the commodity information to said purchaser terminal unit; displays an instruction to secure the availability of the commodity; in response to the entry of the identification number, transmits the identification number to said financial institution terminal unit wherein matching between identification numbers and account numbers is stored in advance to cause the identification number to be converted into the matching account number; causes said booking information matching that account number to be readout; receives that booking information from that financial institution terminal unit; and displays commodity information pertaining to that booking information.

A first purchase information management system according to the invention comprises a credit card company terminal unit for storing commodity sale information and credit card numbers matched with each other; and a commodity delivery management terminal unit for acquiring, in response to the entry of a credit card number, said sale information matching that credit card number from said credit card company terminal unit and displaying commodity information pertaining to that sale information.

A second purchase information management system according to the invention comprises a POS terminal unit for transmitting commodity sale information and a credit card number to a credit card company terminal unit to cause them to be stored matched with each other; and a commodity exchange management terminal unit for transmitting, in response to the entry of the credit card number, that credit card number to said credit card company terminal unit to cause said sale information matching that credit card number to be read out, receiving that sale information from that credit card company terminal unit, and displaying commodity information pertaining to that sale information.

A third purchase information management system according to the invention comprises a POS terminal unit for transmitting commodity sale information and a credit card number to a credit card company terminal unit to cause that sale information to be processed for settlement, causing that sale information and that credit card number to be stored matched with each other, transmitting a notice that the account settlement has been completed to a commodity exchange management terminal unit, and displaying information regarding the delivery of a commodity, wherein said commodity exchange management terminal unit receives from said POS terminal unit a notice that the account settlement has been completed; displays an instruction to secure the availability of the commodity pertaining to that settlement; transmits, in response to the entry of the credit card number, that credit card number to said credit card company terminal unit to cause said sale information matching that credit card number to be read out; receives that sale information from that credit card company terminal unit; and displays commodity information pertaining to that sale information.

A fourth purchase information management system according to the invention is a version of any of the first through third purchase information management system, wherein the counterpart of said credit card number is an account number and that of said credit card company terminal unit is a financial institution terminal unit.

A first commodity delivery management terminal unit according to the invention transmits, in response to the entry of a credit card number, the entered credit card number to a credit card company terminal unit, storing commodity sale information and credit card numbers matched with each other, to cause said sale information matching that credit card number to be read out; receives that sale information from that credit card company terminal unit; and displays commodity information pertaining to that sale information.

A second commodity delivery management terminal unit according to the invention displays, when a notice that the account settlement has been completed is received from a POS terminal unit, an instruction to secure the availability of the commodity pertaining to that settlement; transmits, in response to the entry of a credit card number, the credit card number to a credit card company terminal unit, storing commodity sale information and credit card numbers matched with each other, to cause said sale information matching that credit card number to be read out; receives that sale information from that credit card company terminal unit; and displays commodity information pertaining to that sale information.

A third commodity delivery management terminal unit according to the invention is a version of either of the first or second commodity delivery management system, wherein the counterpart of said credit card number is an account number and that of said credit card company terminal unit is a financial institution terminal unit.

A fourth commodity delivery management terminal unit according to the invention transmits, in response to the entry of an identification number, the entered identification number to a financial institution terminal unit holding in advance a matching table of identification numbers and account numbers and storing identification numbers and commodity sale information matched with each other to convert it into the matching account number; causes said sale information matching that account number to be read out; receives that sale information from that financial institution terminal unit; and displays commodity information pertaining to that sale information.

A fifth commodity delivery management terminal unit according to the invention displays, when a notice that the account settlement has been completed is received from a POS terminal unit, an instruction to secure the availability of the commodity pertaining to that settlement; transmits, in response to the entry of an identification number, the entered identification number to a financial institution terminal unit holding in advance a matching table of identification numbers and account numbers and storing identification numbers and commodity sale information matched with each other to convert it into the matching account number; causes said sale information matching that account number to be read out; receives that sale information from that financial institution terminal unit; and displays commodity information pertaining to that sale information.

### BRIEF DESCRIPTION OF THE DRAWINGS

The present invention will be understood more fully from the detailed description given here below and from the accompanying drawings of preferred embodiments thereof, which, however, should not be regarded as limiting the invention but are only for facilitating explanation and understanding.

FIG. 1 is a block diagram illustrating a first preferred embodiment of the invention.

FIG. 2 is a flow chart shoring the operation of the first preferred embodiment of the invention.

FIG. 3 is a block diagram illustrating a second preferred embodiment of the invention.

FIG. 4 is a flow chart shoring the operation of the second preferred embodiment of the invention.

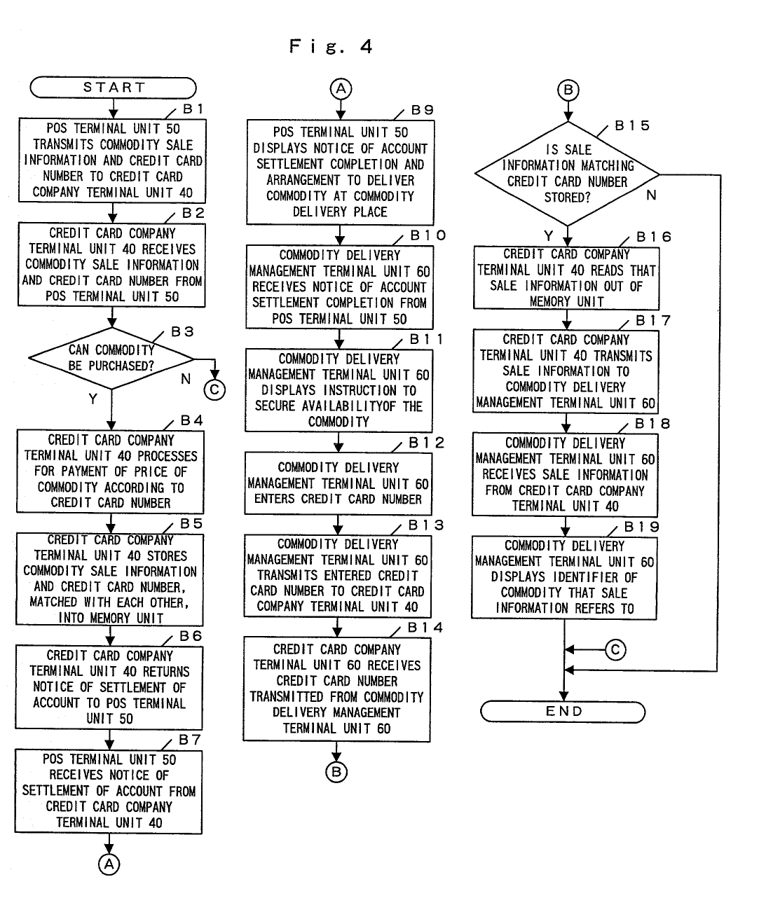

Here, it should be noted that like reference numerals represent like elements throughout the disclosure.

### DETAILED DESCRIPTION OF THE PREFERRED EMBODIMENTS

Preferred embodiments of the present invention will be described in detail below with reference to the- accompanying drawings.

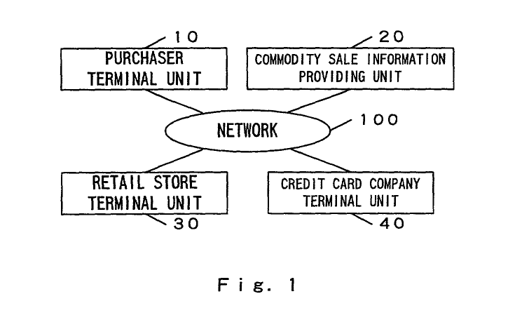

Referring to FIG. 1, a booking information management system, which is a first preferred embodiment of the invention, comprises a purchaser terminal unit 10 for use by a purchaser intending to purchase a commodity, a commodity sale information providing unit 20 for providing commodity sale information, a retail store terminal unit 30 for installation in a retail store selling the commodity, and a credit card company terminal unit 40 for installation in the credit card company providing the pertinent credit card service, all connected to the Internet (network) 100.

Each of the purchaser terminal unit 10, the commodity sale information providing unit 20, the retail store terminal unit 30 and the credit card company terminal unit 40 is a data processing device provided with a display unit and input units including a keyboard, a mouse and a credit card reader, and executes the steps of processing to be described below in accordance with a program read in from a recording medium not shown.

It is also conceivable to remove the commodity sale information providing unit 20 from this embodiment and cause the retail store terminal unit 30 to perform operations including the steps to be otherwise performed by the commodity sale information providing unit 20 as described below.

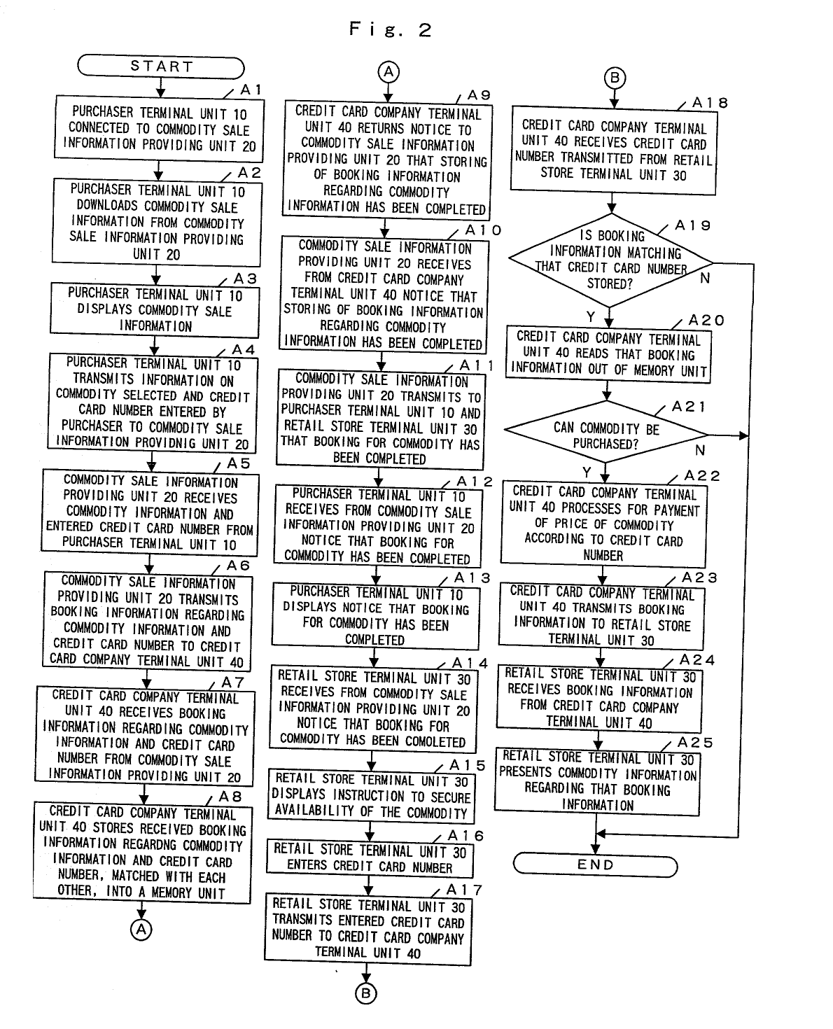

Next will be described with reference to FIG. 2 the booking information management system, which is the first preferred embodiment of the invention.

First, the retail store registers commodity sale information with the commodity sale information providing unit 20 in advance. The purchaser terminal unit 10, as instructed by the purchaser, establishes connection to the commodity sale information providing unit 20 via the Internet 100 (step Al), and commodity sale information is downloaded from the commodity sale information providing unit 20 (from the web site established by the commodity sale information providing unit 20 on the Internet 100) to the purchaser terminal unit 10 (step A2) and displayed (step A3).

The purchaser terminal unit 10 transmits to the commodity sale information providing unit 20 via the Internet 100 commodity information designated (selected) by the purchaser having referenced the commodity sale information displayed at step A3 (including at least the identifier of the commodity and the price of the commodity) and the credit card number entered by the purchaser (step A4).

The commodity sale information providing unit 20 receives the commodity information and the credit card number from the purchaser terminal unit 10 (step A5), and transmits to the credit card company terminal unit 40 via the Internet 100 booking information pertaining to the commodity information (including at least the commodity information) and the pertinent credit card number (step A6).

The credit card company terminal unit 40 receives the booking information and the credit card number transmitted from the commodity sale information providing unit 20 (step A7), stores them matched with each other into a memory unit not shown (step A8), and answers to the commodity sale information providing unit 20 via the Internet 100 that storing of the booking information transmitted at step A6 has been completed (step A9).

The commodity sale information providing unit 20 receives from the credit card company terminal unit 40 a notice to the effect that storing of the booking information has been completed (step A10), and transmits to the purchaser terminal unit 10 and the retail store terminal unit 30 via the Internet 100 that booking for the commodity pertaining to the commodity information transmitted at step A4 has been completed (step A11).

The purchaser terminal unit 10 receives from the commodity sale information providing unit 20 a notice to the effect that the booking for the commodity has been completed (step A12), and presents a display to that effect (step A13).

The retail store terminal unit 30 receives from the commodity sale information providing unit 20 a notice to the effect that the booking for the commodity has been completed (step A14), and displays an instruction to personnel of the retail store to secure the availability of the commodity (step A15).

The retail store terminal unit 30 enters the credit card number according to the credit card presented by the purchaser having come to the retail store (step A16), and transmits that credit card number to the credit card company terminal unit 40 via the Internet 100 (step A17).

The credit card company terminal unit 40 receives the credit card number transmitted from the retail store terminal unit 30 (step A18), determines whether or not booking information matching that credit card number is stored in its own memory unit (step A19). If it is, the credit card company terminal unit 40 reads that booking information out of the memory unit (step A20), determines whether or not the purchaser can purchase the commodity on the basis the price of the commodity pertaining to that booking information and the credit card number (step A21). If he or she can, the credit card company terminal unit 40 processes the payment of the price of the commodity by that credit card number (step A22), and transmits booking information to the retail store terminal unit 30 via the Internet 100 (step A23)

Incidentally the credit card company terminal unit 40, if it determines at step A19 that the booking information is not stored, transmits information to that effect to the retail store terminal unit 30 via the Internet 100 to make it known to the purchaser. Also, if it is determined at step A21 that he or she cannot purchase the commodity, the credit card company terminal unit 40 also transmits the determination to the retail store terminal unit 30 via the Internet 100 to make it known to the purchaser.

The retail store terminal unit 30 receives booking information from the credit card company terminal unit 40 (step A24), presents commodity information pertaining to that booking information (step A25), and causes the commodity indicated by the commodity information to be delivered to the purchaser.

This completes the processing by the booking information management system, which is the first preferred embodiment of the invention.

In a possible variation of this embodiment, the purchaser terminal unit 10 is dispensed with, and the purchaser can directly call the commodity sale information providing unit 20 or the retail store terminal unit 30 by telephone, tell them his or her credit card number, and book the purchase of a commodity. In this case, the operations of the commodity sale information providing unit 20 or the retail store terminal unit 30 and the credit card company terminal unit 40 will be unchanged except that the interface with the purchaser terminal unit 10 is replaced by telephone contact with the purchaser.

In another variation of this embodiment, the credit card company terminal unit 40 installed in the credit card company may be replaced by a financial institution terminal unit 40 installed in a financial institution, such as a bank or a so-called consumer finance company. In this case, the credit card number in the foregoing description shall read the account number. While it is also possible to use an identification number such as a personal ID number in place of the account number, in this case the processing described above can be performed by the financial institution terminal unit 40 if the unit is caused to hold a matching table for identification numbers and account numbers and thereby enabled to identify the account number matching an entered identification number. The booking information management system, which is the first preferred embodiment of the invention, by causing the credit card company managing credit cards a purchaser uses in purchasing a commodity to manage information on commodity booking by the purchaser, provides the benefit of enabling the purchaser to book and purchase commodities without having to manage booking information for himself or herself.

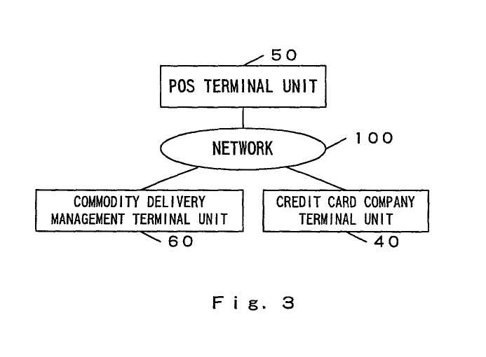

Referring to FIG. 3, a purchase information management system, which is a second preferred embodiment of the invention, comprises a POS terminal unit 50 for entering commodity sale information, a credit card company terminal unit 40 installed in a credit card company providing credit card service, and a commodity delivery management terminal unit 60 installed in the commodity delivery place, all connected via the Internet (network) 100.

Each of the credit card company terminal unit 40, the POS terminal unit 50 and the commodity delivery management terminal unit 60 is a data processing device provided with a display unit and input units including a keyboard, a mouse and a credit card reader, and executes the steps of processing to be described below in accordance with a program read in from a recording medium not shown.

Next will be described with reference to FIG. 2 the purchase information management system, which is the second preferred embodiment of the invention.

The POS terminal unit 50 enters sale information on the commodity purchased by the purchaser (including at least the identifier and the price of the commodity), reads the credit card number from the credit card presented by the purchaser, and transmits the sale information and the credit card number to the credit card company terminal unit 40 via the Internet 100 (step B1).

The credit card company terminal unit 40 receives the sale information and the credit card number transmitted from the POS terminal unit 50 (step B2); determines whether or not it is possible for the purchaser to purchase the commodity according to the price of the commodity that sale information refers to and the credit card number (step B3); if it is possible, processes for payment of the price of the commodity by the credit card number (step B4); stores the sale information and the credit card number, matched with each other, into its own memory unit not shown (step B5); and transmits a notice of the settlement of the account to the POS terminal unit 50 to via the Internet 100 (step B6).

The credit card company terminal unit 40, if it determines at step B3 that the intended purchase is impossible, transmits a notice of impossibility to the POS terminal unit 50 via the Internet 100 to have the fact to be presented to the purchaser.

The POS terminal unit 50 receives from the credit card company terminal unit 40 the notice of the settlement of the account pertaining to the commodity sale information (step B7), transmits the notice to the commodity delivery management terminal unit 60 via the Internet 100 (step B8), presents to the purchaser the fact that the account pertaining to the commodity sale information has been settled and the arrangement of delivering the commodity at the commodity delivery place (step B9).

The commodity delivery management terminal unit 60 receives from the POS terminal unit 50 the notice that the account pertaining to the commodity sale information has been settled (step B10), and presents to the staff of the commodity delivery place an instruction to secure the availability of the commodity (step B11).

The commodity delivery management terminal unit 60 enters the credit card number from the credit card presented by the purchaser having come to pick up the commodity (step B12), and transmits that credit card number to the credit card company terminal unit 40 via the Internet 100 (step B13).

The credit card company terminal unit 40 receives the credit card number transmitted from the commodity delivery management terminal unit 60 (step B14); determines whether or not sale information matching that credit card number is stored in its own memory unit (step B15); if it is, reads that sale information out of the memory unit (step B16); and transmits that sale information to the commodity delivery management terminal unit 60 via the Internet 100 (step B17).

The credit card company terminal unit 40, if it determines at step B15 that the sale information is not stored, transmits a notice of the absence of information to the commodity delivery management terminal unit 60 via the Internet 100 to have the fact to be presented to the purchaser.

The commodity delivery management terminal unit 60 receives sale information from the credit card company terminal unit 40 (step B18), presents the identifier of the commodity that sale information refers to (step B19), and causes the commodity indicated by the commodity identifier to be delivered to the purchaser.

This completes the processing by the purchase information management system, which is the second preferred embodiment of the invention.

In a possible variation of this embodiment, the credit card company terminal unit 40 installed in the credit card company may be replaced by a financial institution terminal unit 40 installed in a financial institution, such as a bank or a so-called consumer finance company. In this case, the credit card number in the foregoing description shall read the account number. While it is also possible to use an identification number such as a personal ID number in place of the account number, in this case the processing described above can of course be performed by the financial institution terminal unit 40 if the unit is caused to hold a matching table for identification numbers and account numbers and thereby enabled to identify the account number matching an entered identification number.

The purchase information management system, which is the second preferred embodiment of the invention, by causing the credit card company managing credit cards a purchases uses when purchasing a commodity to manage information on commodity booking by that purchaser, provides the benefit of enabling the purchaser to receive commodities at the commodity delivery place without having to manage sale information for himself or herself.

As hitherto described, the present invention, by causing the credit card company managing the credit card a purchaser uses in purchasing commodities to manage that purchaser's booking information or sale information, provides the benefit enabling the purchaser to book and purchase commodities without having to bear anything extra other than what he or she usually bear.

Although the invention has been described in detail above with reference to various preferred embodiments thereof, it will be appreciated by those skilled in the art that these embodiments have been described solely for the purposes of illustration, and are in no way to be regarded as limiting the invention. Instead, various modifications and substitutions of equivalent techniques will be apparent to those skilled in the art upon reading this specification, and such modifications and substitutions are to be regarded as falling under the true scope and spirit of the following claims.

What is claimed is:

1. A booking information management system comprising:
a credit card company terminal unit for storing sale information and a credit card number matched with each other; and
a retail store terminal unit for acquiring, in response to the entry of a credit card number, said booking information matching the credit card number from said credit card company terminal unit, and displaying commodity information pertaining to the booking information.

2. The booking information management system, as claimed in claim 1, wherein:
the counterpart of said credit card number is an account number and that of said credit card company terminal unit is a financial institution terminal unit.

3. A booking information management system comprising:
a purchaser terminal unit for transmitting a credit card number and commodity information to a retail store terminal unit, wherein:
said retail store terminal unit transmits to a credit card company terminal unit said credit card number and booking information pertaining to said commodity information received from said purchaser terminal unit and causes them to be stored matched with each other; in response to the entry of the credit card number, transmits that credit card number to said credit card company terminal unit to cause said booking information matching that credit card number to be read out; receives that booking information from that credit card company terminal unit; and displays commodity information pertaining to that booking information.

4. The booking information management system, as claimed in claim 3, wherein:
the counterpart of said credit card number is an account number and that of said credit card company terminal unit is a financial institution terminal unit.

5. A booking information management system comprising:
a purchaser terminal unit for displaying commodity sale information and transmitting commodity information selected from that sale information and an entered credit card number to a retail store terminal unit, wherein:
said retail store terminal unit transmits to a credit card company terminal unit said credit card number and booking information pertaining to said commodity information received from said purchaser terminal unit and causes them to be stored matched with each other; transmits to said purchaser terminal unit a notice that booking for the commodity pertaining to that commodity information has been completed; displays an instruction to secure the availability of that commodity; in response to the entry of the credit card number, transmits that credit card number to said credit card company terminal unit to cause said booking information matching that credit card number to be read out; receives that booking information from that credit card company terminal unit; and-displays commodity information pertaining to that booking information.

6. The booking information management system, as claimed in claim 5, wherein:
the counterpart of said credit card number is an account number and that of said credit card company terminal unit is a financial institution terminal unit.

7. A booking information management system comprising:
a purchaser terminal unit for transmitting an entered credit card number and commodity information to a commodity sale information providing unit, wherein:
said commodity sale information providing unit transmits to a credit card company terminal unit said credit card number and booking information pertaining to said commodity information received from said purchaser terminal unit and causes them to be stored matched with each other; and
a retail store terminal unit, in response to the entry of the credit card number, transmits that credit card number to said credit card company terminal unit to cause said booking information matching that credit card number to be read out; receives that booking information from that credit card company terminal unit; and displays commodity information pertaining to that booking-information.

8. The booking information management system, as claimed in claim 7, wherein:
the counterpart of said credit card number is an account number and that of said credit card company terminal unit is a financial institution terminal unit.

9. A booking information management system comprising:
a purchaser terminal unit for displaying commodity sale information and transmitting commodity information selected from that sale information and entered credit card number to a commodity sale information providing unit; and
said commodity sale information providing unit transmits to a credit card company terminal unit said credit card number and booking information pertaining to said commodity information received from said purchaser terminal unit and causes them to be stored matched with each other; and transmits to said purchaser terminal unit and a retail store terminal unit a notice that booking for the commodity pertaining to that commodity information has been completed; and
said retail store terminal unit receives from said commodity sale information terminal unit the notice that booking for the commodity has been completed; displays an instruction to secure the availability of that commodity; in response to the entry of the credit card number, transmits that credit card number to said credit card company terminal unit to cause said booking information matching that credit card number to be read out; receives that booking information from that credit card company terminal unit; and displays commodity information pertaining to that booking information.

10. The booking information management system, as claimed in claim 9, wherein:
the counterpart of said credit card number is an account number and that of said credit card company terminal unit is a financial institution terminal unit.

11. A retail store terminal unit for:
transmitting a credit card number and booking information pertaining to commodity information to a credit card company terminal unit to cause them to be stored matched with each other; in response to the entry of the credit card number, transmitting that credit card number to said credit card company terminal unit to cause said booking information matching that credit card number to be read out; receiving that booking information from that credit card company terminal unit; and displaying commodity information pertaining to that booking information.

12. The retail store terminal unit, as claimed in claim 11, wherein:
the counterpart of said credit card number is an account number and that of said credit card company terminal unit is a financial institution terminal unit.

13. A retail store terminal unit for:
transmitting to a credit card company terminal unit a credit card number and booking information pertaining to commodity information received from a purchaser terminal unit to cause them to be stored matched with each other; transmitting to said purchaser terminal unit a notice that booking for the commodity pertaining to that commodity information has been completed; displaying an instruction to secure the availability of that commodity; in response to the entry of the credit card number, transmitting that credit card number to said credit card company terminal unit to cause said booking information matching that credit card number to be read out; receiving that booking information from that credit card company terminal unit; and displaying commodity information pertaining to that booking information.

14. The retail store terminal unit, as claimed in claim 13, wherein:
the counterpart of said credit card number is an account number and that of said credit card company terminal unit is a financial institution terminal unit.

15. A retail store terminal unit for:
transmitting an identification number and booking information pertaining to commodity information to a financial institution terminal unit and causing them to be stored matched with each other; in response to the entry of the identification number, transmitting the identification number to said financial institution terminal unit wherein matching between identification numbers and account numbers is stored in advance to cause the identification number to be converted into the matching account number; causing said booking information matching that account number to be read out; receiving that booking information from that financial institution terminal unit; and displaying commodity information pertaining to that booking information.

16. A retail store terminal unit for:
transmitting an identification number and booking information pertaining to commodity information received from a purchaser terminal unit to a financial institution terminal unit and causing them to be stored matched with each other; transmitting a notice of completion of booking for the commodity pertaining to the commodity information to said purchaser terminal unit; displaying an instruction to secure the availability of the commodity; in response to the entry of the identification number, transmitting the identification number to said financial institution terminal unit wherein matching between identification numbers and account numbers is stored in advance to cause the identification number to be converted into the matching account number; causing said booking information matching that account number to be read out; receiving that booking information from that financial institution terminal unit; and displaying commodity information pertaining to that booking information.

17. A purchase information management system comprising: a credit card company terminal unit for storing commodity sale information and credit card numbers matched with each other; and
a commodity delivery management terminal unit for acquiring, in response to the entry of a credit card number, said sale information matching that credit card number from said credit card company terminal unit and displaying commodity information pertaining to that sale information.

18. The purchase information management system, as claimed in claim 17, wherein:
the counterpart of said credit card number is an account number and that of said credit card company terminal unit is a financial institution terminal unit.

19. A purchase information management system comprising: a POS terminal unit for transmitting commodity sale information and a credit card number to a credit card company terminal unit to cause them to be stored matched with each other; and
a commodity exchange management terminal unit for transmitting, in response to the entry of the credit card number, that credit card number to said credit card company terminal unit to cause said sale information matching that credit card number to be read out, receiving that sale information from that credit card company terminal unit, and displaying commodity information pertaining to that sale information.

20. The purchase information management system, as claimed in claim 19, wherein:
the counterpart of said credit card number is an account number and that of said credit card company terminal unit is a financial institution terminal unit.

21. A purchase information management system comprising:
a POS terminal unit for transmitting commodity sale information and a credit card number to a credit card company terminal unit to cause that sale information to be processed for settlement, causing that sale information and that credit card number to be stored matched with each other, transmitting a notice that the account settlement has been completed to a commodity exchange management terminal unit, and displaying information regarding the delivery of a commodity, wherein:
said commodity exchange management terminal unit receives from said POS terminal unit a notice that the account settlement has been completed; displays an instruction to secure the availability of the commodity pertaining to that settlement; transmits, in response to the entry of the credit card number, that credit card number to said credit card company terminal unit to cause said sale information matching that credit card number to be read out; receives that sale information from that credit card company terminal unit; and displays commodity information pertaining to that sale information.

22. The purchase information management system, as claimed in claim 21, wherein:
the counterpart of said credit card number is an account number and that of said credit card company terminal unit is a financial institution terminal unit.

23. A commodity delivery management terminal unit for:
transmitting, in response to the entry of a credit card number, the entered credit card number to a credit card company terminal unit, storing commodity sale information and credit card numbers matched with each other, to cause said sale information matching that credit card number to be read out; receiving that sale information from that credit card company terminal unit; and displaying commodity information pertaining to that sale information.

24. The commodity delivery management terminal unit, as claimed in claim 23, wherein:
the counterpart of said credit card number is an account number and that of said credit card company terminal unit is a financial institution terminal unit.

25. A commodity delivery management terminal unit for:
displaying, when a notice that the account settlement has been completed is received from a POS terminal unit, an instruction to secure the availability of the commodity pertaining to that settlement; transmitting, in response to the entry of a credit card number, the credit card number to a credit card company terminal unit, storing commodity sale information and credit card numbers matched with each other, to cause said sale information matching that credit card number to be read out; receiving that sale information from that credit card company terminal unit; and displaying commodity information pertaining to that sale information.

26. The commodity delivery management terminal unit, as claimed in claim 25, wherein:
the counterpart of said credit card number is an account number and that of said credit card company terminal unit is a financial institution terminal unit.

27. A commodity delivery management terminal unit for:
transmitting, in response to the entry of an identification number, the entered identification number to a financial institution terminal unit holding in advance a matching table of identification numbers and account numbers and storing identification numbers and commodity sale information matched with each other to convert it into the matching account number; causing said sale information matching that account number to be read out; receiving that sale information from that financial institution terminal unit; and displaying commodity information pertaining to that sale information.

28. A commodity delivery management terminal unit for:
displaying, when a notice that the account settlement has been completed is received from a POS terminal unit, an instruction to secure the availability of the commodity pertaining to that settlement; transmitting, in response to the entry of an identification number, the entered identification number to a financial institution terminal unit holding in advance a matching table of identification numbers and account numbers and storing identification numbers and commodity sale information matched with each other to convert it into the matching account number; causing said sale information matching that account number to be read out; receiving that sale information from that financial institution terminal unit; and displaying commodity information pertaining to that sale information.

29. A booking information management method comprising steps of:
storing, by a credit card company terminal, of unit commodity booking information and credit card numbers matched with each other; and
acquiring by a retail store terminal unit, in response to the entry of a credit card number, of said booking information matching that credit card number from said credit card company terminal unit and displaying of commodity information pertaining to that booking information.

30. The booking information management method, as claimed in claim 29, wherein:
the counterpart of said credit card number is an account number and that of said credit card company terminal unit is a financial institution terminal unit.

31. A booking information management method comprising steps of:
transmitting, by a purchaser terminal unit, of a credit card number and commodity information to a retail store terminal unit; and
transmitting, by said retail store terminal unit, of said credit card number and said booking information pertaining to commodity information received from said purchaser terminal unit to a credit card company terminal unit to cause them to be stored matched with each other: transmitting, in response to the entry of the credit card number, of that credit card number to said credit card company terminal unit to cause said booking information matching that credit card number to be read out; receiving of that booking information from that credit card company terminal unit; and displaying commodity information pertaining to that booking information.

32. The booking information management method, as claimed in claim 31, wherein:
the counterpart of said credit card number is an account number and that of said credit card company terminal unit is a financial institution terminal unit.

33. A booking information management method comprising steps of:
displaying, by a purchaser terminal unit, of commodity sale information and transmitting commodity information selected from that sale information and an entered credit card number to a retail store terminal unit;
transmitting, by said retail store terminal unit, of said credit card number and said booking information pertaining to commodity information received from said purchaser terminal unit to credit card company terminal unit to cause them to be stored matched with each other; transmitting a notice that booking for the commodity pertaining to the commodity information has been completed to said purchaser terminal unit; displaying an instruction to secure the availability of the commodity; transmitting, in response to the entry of a credit card number, of that credit card number to said credit card company terminal unit to cause said booking information matching that credit card number to be read out; receiving that booking information from that credit card company terminal unit; and displaying commodity information pertaining to that booking information.

34. The booking information management method, as claimed in claim 33, wherein:
the counterpart of said credit card number is an account number and that of said credit card company terminal unit is a financial institution terminal unit.

35. A booking information management method comprising steps of:
transmitting, by a purchaser terminal unit, of an entered credit card number and commodity information to a commodity sale information providing unit;
transmitting, by said commodity sale information providing unit, of said credit card number and said booking information pertaining to commodity information received from said purchaser terminal unit to a credit card company terminal unit to cause them to be stored matched with each other; and
transmitting by a retail store terminal unit, in response to the entry of a credit card number, of that credit card number to said credit card company terminal unit to cause said booking information matching that credit card number to be read out; receiving that booking information fromthat credit card company terminal unit; and
displaying commodity information pertaining to that booking information.

36. The booking information management method, as claimed in claim 35, wherein:
the counterpart of said credit card number is an account number and that of said credit card company terminal unit is a financial institution terminal unit.

37. A booking information management method comprising steps of:
displaying, by a purchaser terminal unit, of commodity sale information; and transmitting of commodity information selected from that sale information and an entered credit card number to a commodity sale information providing unit;
transmitting, by said commodity sale information providing unit, of said credit card number and said booking information pertaining to commodity information received from said purchaser terminal unit to a credit card company terminal unit to cause them to be stored matched with each other; and transmitting a notice that booking for the commodity pertaining to the commodity information has been completed to said purchaser terminal unit and a retail store terminal unit; and
receiving, by said retail store terminal unit, of the notice that booking for the commodity has been completed from said commodity sale information terminal unit; displaying an instruction to secure the availability of the commodity; and in response to the entry of a credit card number transmitting that credit card number to said credit card company terminal unit cause said booking information matching that credit card number to be read out; receiving that booking information from that credit card company terminal unit; and displaying commodity information pertaining to that booking information.

38. The booking information management method, as claimed in claim 37, wherein:
the counterpart of said credit card number is an account number and that of said credit card company terminal unit is a financial institution terminal unit.

39. A method whereby a retail store terminal unit transmits a credit card number and booking information pertaining to commodity information to a credit card company terminal unit to cause them to be stored matched with each other; transmits, in response to the entry of the credit card number, that credit card number to said credit card company terminal unit to cause said booking information matching that credit card number to be read out; receives that booking information from that credit card company terminal unit; and displays commodity information pertaining to that booking information.

40. The method, as claimed in claim 39, wherein:
the counterpart of said credit card number is an account number and that of said credit card company terminal unit is a financial institution terminal unit.

41. A method whereby a retail store terminal unit transmits to a credit card company terminal unit a credit card number and booking information pertaining to commodity information received from a purchaser terminal unit to cause them to be stored matched with each other; transmits a notice that booking for the commodity pertaining to the commodity information has been completed to said purchaser terminal unit; displays an instruction to secure the availability of the commodity; in response to the entry of the credit card number, transmits that credit card number to said credit card company terminal unit to cause said booking information matching that credit card number to be read out; receives that booking information from that credit card company terminal unit; and displays commodity information pertaining to that booking information.

42. The method, as claimed in claim 41, wherein:
the counterpart of said credit card number is an account number and that of said credit card company terminal unit is a financial institution terminal unit.

43. A method whereby a retail store terminal unit transmits an identification number and booking information pertaining to commodity information to a financial institution terminal unit to have them matched with each other; in response to the entry of the identification number, transmits the entered identification number to said financial institution terminal unit, in which matching between identification numbers and account numbers is stored in advance, to have it converted into the matching account number; causes said booking information matching that account number to be read out; receives that booking information from that financial institution terminal unit; and displays commodity information pertaining to that booking information.

44. A method whereby a retail store terminal unit transmits an identification number and booking information pertaining to commodity information received from a purchaser terminal unit to a financial institution terminal unit to cause them to be stored matched with each other; transmits to said purchaser terminal unit a notice that booking for the commodity pertaining to the commodity information has been completed; displays an instruction to secure the availability of the commodity; in response to the entry of the identification number, transmits the entered identification number to said financial institution terminal unit, in which matching between identification numbers and account numbers is stored in advance, to have it converted into the matching account number; causes said booking information matching that account number to be read out; receives that booking information from that financial institution terminal unit; and displays commodity information pertaining to that booking information.

45. A purchase information management method comprising steps of:
storing, by a credit card company terminal unit, of commodity sale information and credit card numbers matched with each other; and
acquiring in response to the entry of a credit card number, by a commodity delivery management terminal unit, of said sale information matching that credit card number from said credit card company terminal unit; and displaying commodity information pertaining to that sale information.

46. The purchase information management method, as claimed in claim 45, wherein:
the counterpart of said credit card number is an account number and that of said credit card company terminal unit is a financial institution terminal unit.

47. A purchase information management method comprising steps of:
transmitting, by a POS terminal unit, of commodity sale information and a credit card number to a credit card company terminal unit to cause them to be stored matched with each other; and
transmitting by a commodity exchange management terminal unit, in response to the entry of a credit card number, by a commodity delivery management terminal unit, of that credit card number to said credit card company terminal unit to cause said sale information matching that credit card number to be read out; receiving that sale information from that credit card company terminal unit; and displaying commodity information pertaining to that sale information.

48. The purchase information management method, as claimed in claim 47, wherein:
the counterpart of said credit card number is an account number and that of said credit card company terminal unit is a financial institution terminal unit.

49. A purchase information management method comprising steps of:
transmitting, by a POS terminal unit, of commodity sale information and a credit card number to a credit card company terminal unit to have the account regarding that sale information settled; having that sale information and that credit card number stored matched with each other; transmitting a notice that the account settlement has been completed to a commodity exchange management terminal unit; and displaying information regarding the delivery of a commodity; and
receiving, by said commodity exchange management terminal unit, of the notice that the account settlement has been completed from said POS terminal unit; displaying an instruction to secure the availability of the commodity pertaining to that settlement; in response to the entry of the credit card number, transmitting that credit card number to said credit card company terminal unit to cause said sale information matching that credit card number to be read out; receiving that sale information from that credit card company terminal unit; and displaying commodity information pertaining to that sale information.

50. The purchase information management method, as claimed in claim 49, wherein:
the counterpart of said credit card number is an account number and that of said credit card company terminal unit is a financial institution terminal unit.

51. A method whereby a commodity delivery management terminal unit is responsive to the entry of a credit card number for transmitting the entered credit card number to a credit card company terminal unit storing commodity sale information and credit card numbers matched with each other to cause said sale information matching that credit card number to be read out, that sale information is received from that credit card company terminal unit, and commodity information pertaining to that sale information is displayed.

52. The method, as claimed in claim 51, wherein:
the counterpart of said credit card number is an account number and that of said credit card company terminal unit is a financial institution terminal unit.

53. A method whereby a commodity delivery management terminal unit, when a notice that the account settlement has been completed is received from a POS terminal unit, displays an instruction to secure the availability of the commodity pertaining to that settlement; in response to the entry of a credit card number, transmits the entered credit card number to a credit card company terminal unit storing commodity sale information and credit card numbers matched with each other to cause said commodity sale information matching that credit card number to be read out; receiving that sale information from that credit card company terminal unit; and displays commodity information pertaining to that sale information.

54. The method, as claimed in claim 53, wherein:
the counterpart of said credit card number is an account number and that of said credit card company terminal unit is a financial institution terminal unit.

55. A method whereby a commodity delivery management terminal unit is responsive to the entry of an identification number for transmitting the entered identification number to a financial institution terminal unit holding in advance a matching table of identification numbers and account numbers and storing identification numbers and commodity sale information matched with each other to convert it into the matching account number; causes said sale information matching that account number to be read out; receives that sale information from that financial institution terminal unit; and displays commodity information pertaining to that sale information.

56. A method whereby a commodity delivery management terminal unit, when a notice that the account settlement has been completed is received from a POS terminal unit, displays an instruction to secure the availability of the commodity pertaining to that settlement; in response to the entry of an identification number, transmits the entered identification number to a financial institution terminal unit holding in advance a matching table of identification numbers and account numbers and storing identification numbers and commodity sale information matched with each other to convert it into the matching account number; causes said sale information matching that account number to be read out; receives that sale information from that financial institution terminal unit; and displays commodity information pertaining to that sale information.
